(19) United States
(12) Patent Application Publication
(10) Pub. No.: US 2026/0008193 A1
(43) Pub. Date: Jan. 8, 2026

(54) RAZOR

(71) Applicant: KAI R&D CENTER CO., LTD., Seki-shi, Gifu (JP)

(72) Inventors: Jun OTSUKA, Seki-shi, Gifu (JP); Kengo HASHIMOTO, Seki-shi, Gifu (JP); Kai TAKEUCHI, Seki-shi, Gifu (JP); Kimiko EGAWA, Seki-shi, Gifu (JP)

(73) Assignee: KAI R&D CENTER CO., LTD., Seki-shi, Gifu (JP)

(21) Appl. No.: 18/695,078

(22) PCT Filed: Jan. 11, 2023
(86) PCT No.: PCT/JP2023/000465

§ 371 Date: Mar. 18, 2025

(51) Int. Cl. B26B 21/52

(52) U.S. Cl. CPC B26B 21/522; B26B 21/521

(57) ABSTRACT

A razor has a holder having a planar shape and a head that includes a razor blade and is retained on a side surface on a front side of the holder. In the holder, a ratio of a length (V1) in a vertical direction (V) to a length (W1) in a horizontal direction (W) is in a range of 1:1.2 to 1:2.8, and a ratio of a length (H2) in a thickness direction to a length (V1) in the vertical direction (V) is in a range of 1:1.0 to 1:8.0.

### TECHNICAL FIELD

The present disclosure relates to a razor.

### BACKGROUND ART

Conventionally, various types of razors having vertically long holders such as T-shaped holders are known (see, for example, Patent Literatures 1 to 3).

Further, a razor having a holder whose side surface is a curved surface is known (see, for example, Patent Literatures 4 to 5).

### CITATION LIST

### Patent Literature

Patent Literature 1: DE 102013213859 A1
Patent Literature 2: US 2017190065 A1
Patent Literature 3: Japanese Registered Design No. 1583069
Patent Literature 4: WO 2020148299 A1
Patent Literature 5: EP 1586426 A2

### SUMMARY OF THE INVENTION

### Technical Problem

However, as to each of the razors disclosed in Patent Literatures 1 to 3, the ways to hold the razor are limited, and a user cannot perform “horizontal holding” as illustrated in FIG. 8. This causes a problem that there is a region where the user cannot shave with a natural movement or with his/her wrist relaxed.

Further, as to each of the razors disclosed in Patent Literatures 4 to 5, a user cannot perform “horizontal holding” as illustrated in FIG. 8 and cannot perform “fingertip holding” as illustrated in FIG. 9. This also causes a problem that there is a region where the user cannot shave with a natural movement or with his/her wrist relaxed.

Therefore, the present disclosure has been made in view of the above-described problems, and an object of the present disclosure is to provide a razor that allows a user to shave hair on various parts with a natural movement or with his/her wrist relaxed.

### Solution to Problem

A first aspect of the present disclosure is summarized as a razor including: a holder having a planar shape; and a head that includes a razor blade and is retained on a side surface on a front side of the holder, wherein in the holder, a ratio of a length in a vertical direction to a length in a horizontal direction is in a range of 1:1.2 to 1:2.8, and a ratio of a length in a thickness direction to a length in the vertical direction is in a range of 1:1.0 to 1:8.0.

A second aspect of the present disclosure is summarized as a razor including: a holder having a planar shape; and a head that includes a razor blade and is retained on a side surface on a front side of the holder, wherein the holder has a curved shape that is convex toward an upper side in a thickness direction, when viewed from the upper side, the side surface on the front side of the holder has a curved shape having a first radius of curvature falling in a range of 20 to 1000 mm, when viewed from the upper side, a side surface on a rear side of the holder has a curved shape having a second radius of curvature falling in a range of 10 to 500 mm, when viewed from the upper side, a side surface on a left side and a side surface on a right side of the holder each have a curved shape having a third radius of curvature falling in a range of 4 to 100 mm, the first radius of curvature is larger than the second radius of curvature, and the second radius of curvature is larger than the third radius of curvature.

A third aspect of the present disclosure is summarized as a razor including: a holder having a length in a horizontal direction greater than a length in a vertical direction; and a head that includes a razor blade and is retained on a side surface on a front side of the holder, wherein the holder has a recessed portion on a surface on a lower side.

### Advantageous Effects of Invention

According to the present disclosure, it is possible to provide a razor that allows a user to shave hair on various parts with a natural movement or with his/her wrist relaxed.

### BRIEF DESCRIPTION OF THE DRAWINGS

FIG. 1 is a perspective view (front side F) illustrating an example of an overall configuration of a razor 1 according to an embodiment.

FIG. 2 is an example of a view of the razor 1 illustrated in FIG. 1 as viewed from a lower side D.

FIG. 3 is an example of a view of the razor 1 illustrated in FIG. 1 as viewed from a rear side B.

FIG. 4 is an example of a view of the razor 1 illustrated in FIG. 1 as viewed from the front side F.

FIG. 5 is an example of a view of a state in which a head 20 is detached from the razor 1 according to the embodiment as viewed from the front side F.

FIG. 6 is an example of a view of the razor 1 illustrated in FIG. 1 as viewed from a left side L.

FIG. 7 is a perspective view (rear side B) illustrating an example of the overall configuration of the razor 1 according to the embodiment.

FIG. 8 is a view for explanation of “horizontal holding”.

FIG. 9 is a view for explanation of “fingertip holding”.

### DESCRIPTION OF EMBODIMENTS

Hereinafter, preferred embodiments of the present invention will be described in detail with reference to the accompanying drawings. In the following description of the drawings, the same or similar parts are denoted by the same or similar reference numerals. However, it should be noted that the drawings are schematic, and ratios of dimensions and the like are different from actual ones. Therefore, specific dimensions and the like should be determined in consideration of the following description. In addition, the drawings may include portions having different dimensional relationships and ratios. In the present specification and the drawings, elements having substantially the same function and configuration are denoted by the same reference numerals, and duplicate descriptions are omitted, and elements not directly related to the present invention are not illustrated.

### First Embodiment

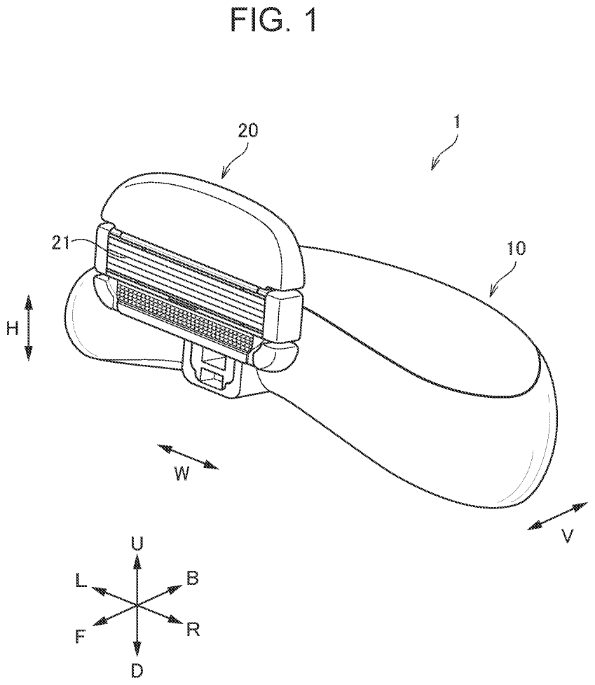

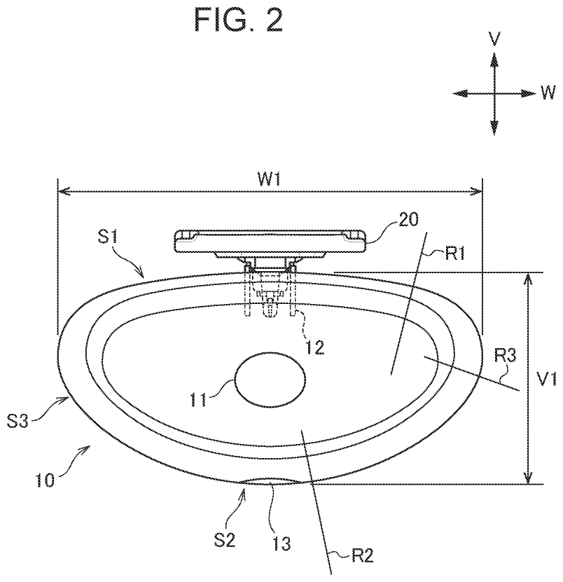

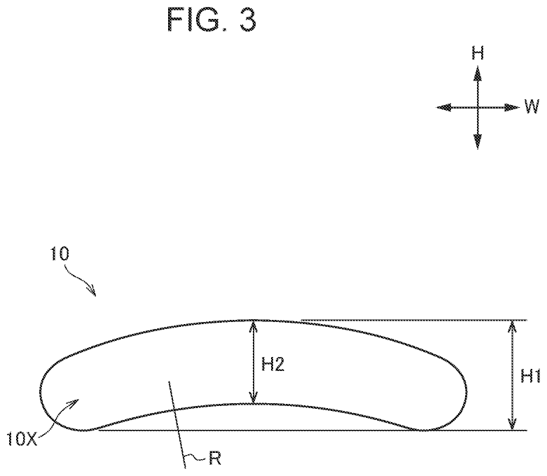

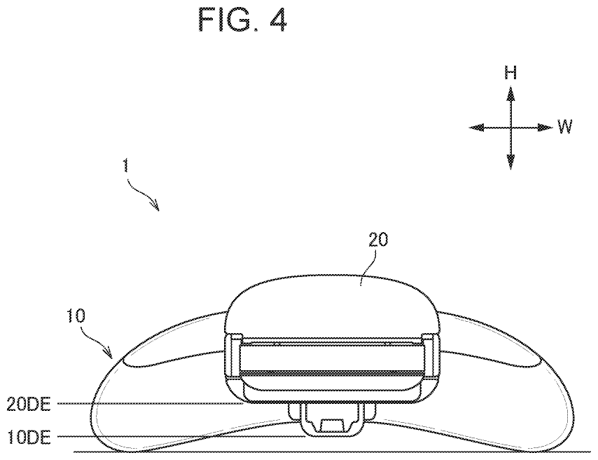

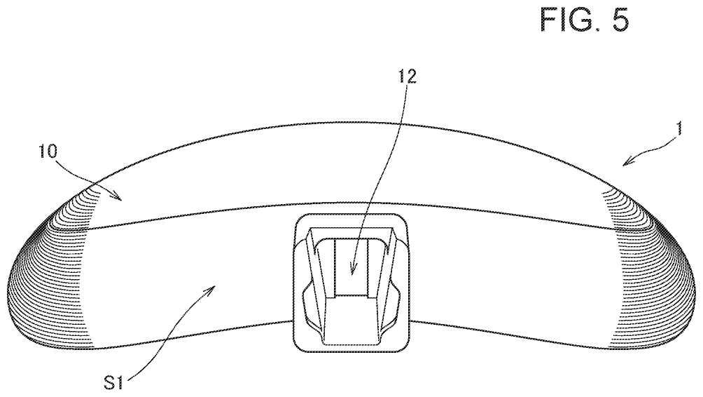

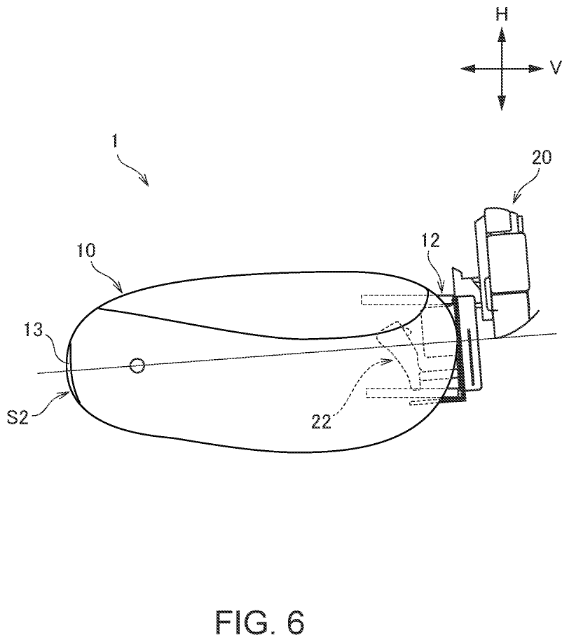

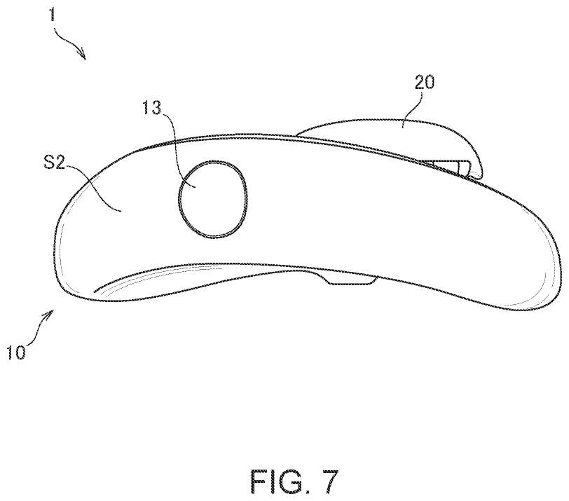

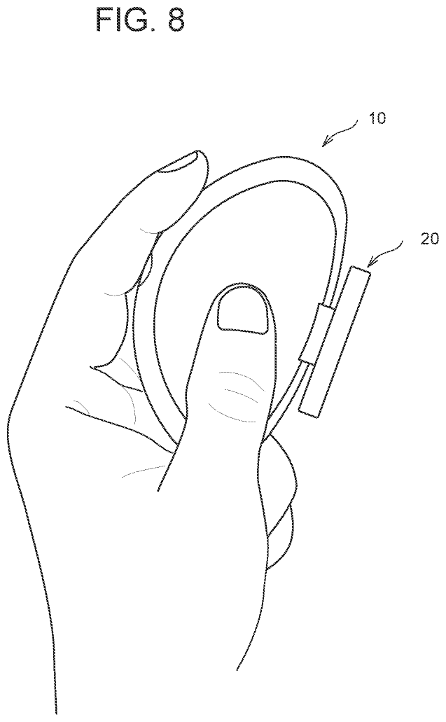

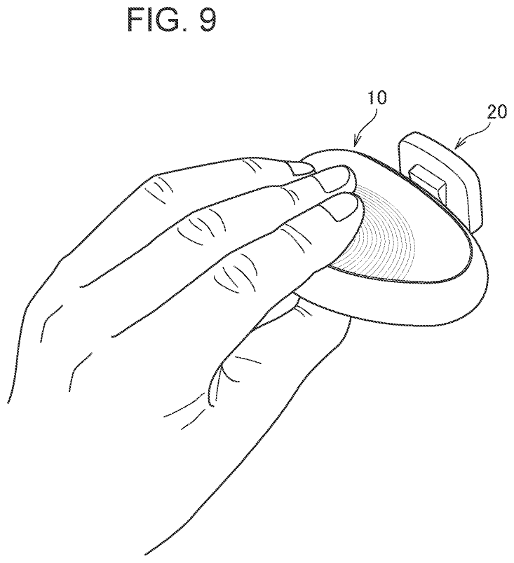

Hereinafter, an embodiment of the present invention will be described with reference to FIGS. 1 to 9. FIG. 1 is a perspective view (front side F) illustrating an example of an overall configuration of a razor 1 according to an embodiment. FIG. 2 is an example of a view of the razor 1 illustrated in FIG. 1 as viewed from a lower side D. FIG. 3 is an example of a view of the razor 1 illustrated in FIG. 1 as viewed from a rear side B. FIG. 4 is an example of a view of the razor 1 illustrated in FIG. 1 as viewed from the front side F. FIG. 5 is an example of a view of a state in which a head 20 is detached from the razor 1 according to the embodiment as viewed from the front side F. FIG. 6 is an example of a view of the razor 1 illustrated in FIG. 1 as viewed from a left side L. FIG. 7 is a perspective view (rear side B) illustrating an example of the overall configuration of the razor 1 according to the embodiment. FIG. 8 is a view for explanation of “horizontal holding”. FIG. 9 is a view for explanation of “fingertip holding”.

As illustrated in FIG. 1, the razor 1 according to the present embodiment has a vertical direction V, a horizontal direction W, and a thickness direction H.

Further, the razor 1 according to the present embodiment has a front side F and a rear side B along the vertical direction V, has a left side L and a right side R along the horizontal direction W, and has an upper side U and a lower side D along the thickness direction H.

In the present embodiment, a case where the side on which the head 20 is retained is the front side F will be described as an example, but the present invention is also applicable to a case where the side on which the head 20 is retained is the rear side B. Similarly, in the present embodiment, as illustrated in FIG. 1, the upper side U and the lower side D are defined for description, but the present invention is also applicable to a case where the definition of the upper side U and the lower side D is opposite to that in FIG. 1.

As illustrated in FIG. 1, the razor 1 according to the present embodiment includes a holder 10 and the head 20.

As illustrated in FIG. 1, the holder 10 has a planar shape. The holder 10 may be made of an ABS resin, an elastomer resin, or the like.

As illustrated in FIGS. 1 and 2, the head 20 is retained on a side surface S1 on the front side F of the holder 10, and includes a razor blade 21. For example, the head 20 may include a plurality of razor blades 21. In a case where the razor 1 is a razor of a type that allows the head 20 to be changed, the head 20 may be called a replacement blade.

As illustrated in FIGS. 2 and 3, as to the holder 10, the ratio of the length V1 in the vertical direction V to the length W1 in the horizontal direction W may be in a range of 1:1.2 to 1:2.8, and the ratio of the thickness H2 to the length V1 in the vertical direction V may be in a range of 1:1.0 to 1:8.0. The ratio of the thickness H2 to the length V1 in the vertical direction V is more preferably in a range of 1:1.5 to 1:8.0.

The inventor experimentally produced holders of various sizes and carried out a use test. Consequently, the inventor confirmed that the holder 10 was easily held by applying those ratios to the holder 10 and was suitable for use in the razor 1. Conversely, the inventor confirmed that, when the ratio was deviated from those ratios, a problem such as a difficulty in horizontal holding was felt.

That is, as to the holder 10, the length W1 in the horizontal direction W is longer than the length V1 in the vertical direction V. Further, as to the holder 10, the length V1 in the vertical direction V is equal to or greater than the thickness H2.

For example, the length V1 of the holder 10 in the vertical direction V may be 24 to 80 mm. The length W1 of the holder 10 in the horizontal direction W may be 30 to 160 mm. The length (height) H1 of the holder 10 in the thickness direction H may be 10 to 60 mm.

According to such a configuration, since the holder 10 has a horizontally long shape and a flat plate shape, a user can easily perform “horizontal holding” and “fingertip holding” on the holder 10.

Here, for example, as illustrated in FIG. 8, in a case where the user holds the holder 10 with the left hand, the “horizontal holding” is a way to hold the holder 10 by placing the thumb on a surface on the upper side U of the holder 10, placing the index finger on a side surface S2 on the rear side B of the holder 10, and placing the middle finger on a surface on the lower side D of the holder 10. Here, the user may further put the ring finger or the little finger on the surface on the lower side D of the holder 10. In a case where the user performs the “horizontal holding”, the entire palm side of the index finger can be placed along the side surface S2 on the rear side B of the holder 10, which enhances a sense of stability in use.

On the other hand, for example, as illustrated in FIG. 9, in a case where the user holds the holder 10 with the left hand, the “fingertip holding” is a way to hold the holder 10 by placing the index finger, the middle finger, and the ring finger on the surface on the upper side U of the holder 10, and placing the thumb on the surface on the lower side D of the holder 10.

The thickness H2 of the holder 10 may be 10 to 40 mm. In a case where the thickness H2 of the holder 10 is less than 10 mm, there is a problem that the touch and feel at the time of use is deteriorated and a sense of stability in use is insufficient. In a case where the thickness H2 of the holder 10 exceeds 40 mm, there is a problem that the “horizontal holding” as illustrated in FIG. 8 is difficult.

As illustrated in FIG. 3, the holder 10 may have a curved shape 10X that is convex toward the upper side U in the thickness direction H. In other words, the holder 10 may have a shape in which the entire surface on the lower side D is recessed. According to such a shape, there is an advantage that the user can easily hold the holder 10 (the holder 10 fits in the finger well) as compared with a holder not having such a shape.

Here, as illustrated in FIG. 3, the radius of curvature R in the curved shape 10X may be 45 to 300 mm. It is also possible that the entire holder 10 does not have a curved shape and a part of the holder 10 has a planar shape or the like.

Further, as illustrated in FIG. 2, the front side surface S1 of the holder 10, the rear side surface S2 of the holder 10, and the left and right side surfaces S3 of the holder 10 may have a curved shape with a first radius of curvature R1, a curved shape with a second radius of curvature R2, and a curved shape with a third radius of curvature R3, respectively.

For example, the first radius of curvature R1 is in a range of 20 to 1000 mm, preferably in a range of 50 to 500 mm, and more preferably in a range of 80 to 250 mm.

The second radius of curvature R2 is in a range of 10 to 500 mm, preferably in a range of 15 to 200 mm, and more preferably in a range of 30 to 100 mm.

Further, the third radius of curvature R3 is in a range of 4 to 100 mm, preferably in a range of 8 to 50 mm, and more preferably in a range of 10 to 30 mm.

Here, the first radius of curvature R1 may be larger than the second radius of curvature R2, and the second radius of curvature R2 may be larger than the third radius of curvature R3.

It is more preferable.

The inventor experimentally produced holders of various sizes and carried out a use test. Consequently, the inventor confirmed that, in the case of horizontal holding, the holder 10 easily fit to the hand and was easy to hold by setting the radius of curvature to be in those ranges.

According to such a configuration, in a state where the holder 10 is placed on a washbasin or the like, a part of the holder 10 does not contact the surface on which the holder 10 is placed, which provides an effect that the user can easily hold the holder 10.

In addition, according to such a configuration, the surface on the upper side U of the holder 10 is convexly curved, which provides an effect that the index finger, the middle finger, the ring finger, or the like can be easily placed in the “fingertip holding”.

As illustrated in FIG. 2, the holder 10 may have a recessed portion 11 on the surface on the lower side U. The recessed portion 11 may have a circular shape, an elliptical shape, or another shape in plan view.

According to such a configuration, the user can hold the holder 10 stably even in the case of shaving with the non-dominant hand, by putting the thumb of the left hand on the recessed portion 11 in the case of the “fingertip holding”, and putting the middle finger or the like of the left hand on the recessed portion 11 in the case of the “horizontal holding”.

As illustrated in FIG. 4, an end 20DE on the lower side D of the head 20 may be provided above an end 10DE on the lower side D of the holder 10.

According to such a configuration, as illustrated in FIGS. 3 and 4, it is possible to prevent the head 20 including the razor blade 21 from coming into contact with a surface on which the holder 10 is placed (for example, a washbasin or the like), which provides an excellent effect in terms of hygiene.

As illustrated in FIGS. 5 and 6, a coupling hole 12 for detachably coupling the head 20 may be provided on the side surface S1 on the front side F of the holder 10. Specifically, the coupling hole 12 may be provided in a central portion, in the horizontal direction W, of the side surface S1 on the front side F of the holder 10.

In addition, as illustrated in FIGS. 6 and 7, an operation portion 13 operated in order to detach the head 20 from the coupling hole 12 may be provided on the side surface S2 on the rear side B of the holder 10.

Specifically, the operation portion 13 may be provided in a central portion, in the horizontal direction W, of the side surface S2 on the rear side B of the holder 10.

As illustrated in FIG. 6, when the user presses the operation portion 13 in a retained state in which a connecting portion 22 of the head 20 is inserted into the coupling hole 12 and retained therein, the connection between the connecting portion 22 and the coupling hole 12 is released, and the head 20 is detached from the coupling hole 12.

The operation portion 13 is provided on the side surface S2 on the rear side B of the holder 10. Thus, in a case where the user performs the “horizontal holding” and the “fingertip holding”, he/she is less likely to press the operation portion 13 by mistake.

According to such a configuration, since the operation portion 13 and the coupling hole 12 face each other along the vertical direction V, pressing on the operation portion 13 by the user can be transmitted to the connecting portion 22 retained in the coupling hole 12 with a simple mechanism.

Further, the outer surface of a button constituting the operation portion 13 may be configured not to protrude from the surface of the side surface S2 on the rear side B of the holder 10. In other words, the outer surface of a button constituting the operation portion 13 and the outer surface of the side surface S2 on the rear side B of the holder 10 may be configured to coincide with each other.

Such a configuration reduces the likelihood that the user using the razor 1 accidentally presses the button constituting the operation portion 13 and the head 10 is detached, and the user can detach the head 20 only when the user intends to.

In the present embodiment, the razor of a type that allows the head 20 to be replaced has been described as an example of the razor 1, but the present invention is not limited to the case of such a razor and is also applicable to a case of a disposable razor, an electric razor (electric shaver), or the like.

According to the razor 1 of the present embodiment, it is possible to easily perform the “fingertip holding” or the “horizontal holding” suitable for shaving hair on the legs or arms of the user.

In general, in a case where the user shaves hair on the legs or the like, the eyes, the hand, the head 20, and a region to be shaved lie on substantially the same straight line, and the region to be shaved is hidden by the holder 10 or the hand, which sometimes makes it difficult for the user to shave while looking at the region. Although it is still good in the case of the dominant hand, in particular, when using the razor with the non-dominant hand, the user sometimes feels slightly uneasy.

Even in such a situation, according to the razor 1 of the present embodiment, the eyes, the hand, the head 20, and a region to be shaved are less likely to lie on the same straight line, the target region is prevented from being hidden by the holder 10 or the hand, the user can shave while looking at the target region, or, the user can shave hair on various regions with a natural movement or with his/her wrist relaxed.

Thus, according to the present invention, the razor 1 can be naturally held with the hand of the user while the user touches the arm or the leg.

Further, according to the present invention, since the user can perform the “horizontal holding” and the “fingertip holding”, he/she can use the razor 1 with a hand and fingers placed at a position close to the head 20 of the razor 1. This allows the user to easily operate the razor 1.

### REFERENCE SIGNS LIST

1 RAZOR
10 HOLDER
11 RECESSED PORTION
12 COUPLING HOLE
13 OPERATION PORTION
20 HEAD
21 RAZOR BLADE
V VERTICAL DIRECTION
W HORIZONTAL DIRECTION
H THICKNESS DIRECTION

1. A razor having a vertical direction including a front side
and a rear side, a horizontal direction including a right side and a left side, and a thickness direction including an upper side and a lower side, the razor comprising:
a holder having a planar shape as a whole and having a curved shape having a radius of curvature falling in a range 45 to 300 mm in lateral view; and
a head that includes a razor blade and is retained on a side surface on a front side of the holder,
wherein:
in the holder, a ratio of a length in a vertical direction to a length in a horizontal direction is in a range of 1:1.2 to 1:2.8, and a ratio of a length in a thickness direction to a length in the vertical direction is in a range of 1:1.0 to 1:8.0,
a coupling hole for detachably coupling the head is provided on the side surface on the front side of the holder, and
an operation portion operated in order to detach the head from the coupling hole is provided on the side surface on the rear side of the holder.

2. A razor having a vertical direction including a front side and a rear side, a horizontal direction including a right side and a left side, and a thickness direction including an upper side and a lower side, the razor comprising:
a holder having a planar shape as a whole and having a curved shape having a radius of curvature falling in a range 45 to 300 mm in lateral view; and
a head that includes a razor blade and is retained on a side surface on a front side of the holder,
wherein:
the holder has a curved shape that is convex toward an upper side in a thickness direction,
when viewed from the upper side, the side surface on the front side of the holder has a curved shape having a first radius of curvature falling in a range of 20 to 1000 mm,
when viewed from the upper side, a side surface on a rear side of the holder has a curved shape having a second radius of curvature falling in a range of 10 to 500 mm,
when viewed from the upper side, a side surface on a left side and a side surface on a right side of the holder each have a curved shape having a third radius of curvature falling in a range of 4 to 100 mm,
the first radius of curvature is larger than the second radius of curvature,
the second radius of curvature is larger than the third radius of curvature,
a coupling hole for detachably coupling the head is provided on the side surface on the front side of the holder, and
an operation portion operated in order to detach the head from the coupling hole is provided on the side surface on the rear side of the holder.

3. A razor having a vertical direction including a front side and a rear side, a horizontal direction including a right side and a left side, and a thickness direction including an upper side and a lower side, the razor comprising:
a holder having a planar shape as a whole, having a length in a horizontal direction greater than a length in a vertical direction, and having a curved shape having a radius of curvature falling in a range 45 to 300 mm in lateral view; and
a head that includes a razor blade and is retained on a side surface on a front side of the holder,
wherein:
a coupling hole for detachably coupling the head is provided on the side surface on the front side of the holder,
an operation portion operated in order to detach the head from the coupling hole is provided on the side surface on the rear side of the holder, and
the holder has a recessed portion on a surface on a lower side.

4-5. (canceled)
